(19) United States
(12) Patent Application Publication
(10) Pub. No.: US 2006/0182133 A1
(43) Pub. Date: Aug. 17, 2006

(54) Data transmission device

(76) Inventors: Takanori Choumaru, Fukuoka (JP); Hiroshi Kinoshita, Fukuoka (JP)

Correspondence Address: KATTEN MUCHIN ROSENMAN LLP, 575 MADISON AVENUE, NEW YORK, NY, 10022-2585, US

(21) Appl. No.: 11/403,515

(22) Filed: Apr. 13, 2006

Related U.S. Application Data
(63) Continuation of application No. PCT/JP03/16005, filed on Dec. 12, 2003.

(51) Int. Cl. H04L 12/56

(52) U.S. Cl. 370/401; 370/254

(57) ABSTRACT

A multiple spanning tree protocol network which does not influence at all MSTI to which VLAN-ID is not added/deleted and does not reconstruct the topology of this MSTI. In the multiple spanning tree protocol network, a plurality of devices are connected via transmission paths, forming a plurality of topologies, and each of the plurality of devices comprises a network identification information processing section for creating network identification information for each topology, a receive section for receiving and extracting the network identification information from an adjacent device, and a topology change detection processing section, comprising a comparison section for comparing the extracted network identification information with the network identification information of the local device generated by the network identification information processing section and detecting the change, and a topology information construction section for reconstructing only the topology of which change has been detected if the comparison section detects the change.

### CROSS REFERENCE TO RELATED APPLICATIONS

This application is a continuation of International Application No. PCT/JP2003/016005, filed on Dec. 12, 2003, now pending, herein incorporated by reference.

### TECHNICAL FIELD

The present invention relates to a data transmission device using Multiple Spanning Tree Protocol (MSTP), which is used in communication businesses that provide wide area LAN services, and a method for constructing an MSTP network comprising these data transmission devices.

### BACKGROUND ART

When a company constructs a private network connecting each base, a method of using leased lines, a method of using an IP-VPN (Virtual Private Network) based on IP (Internet Protocol) or a method of using a wide area LAN service using a VLAN (Virtual Local Area Network) is used.

The wide area LAN service in particular, which is constructed using layer 2 switches, is now rapidly increasing since cost is lower than the case of leased lines or IP-VPN, and management is easy.

FIG. 1 is a diagram depicting a wide area LAN service using VLAN as a prior art.

For example, company A can construct a virtual private network between the head office LAN (LA1) and the branch office LAN (LA2) by setting VLAN ID=1 in the wide area LAN 100.

In this case, if the network is constructed only by layer 2 switches SWs, as in the case of a wide area LAN service, a broadcast storm may be generated because of a plurality of paths existing between two points.

As a technology to avoid this, spanning tree protocol (STP), based on a spanning tree algorithm defined by IEEE 802.1d, is used.

STP determines a layer 2 switch to be a root, sets paths like a tree from there (forwarding), and disables data passing through the paths other than the tree (blocking). By this, a path is uniquely determined between arbitrary layer 2 switches, so the generation of a loop can be prevented.

FIG. 2 shows a configuration example of the spanning tree based on STP. By setting paths using forwarding where data passes, indicated by a bold line, and blocking where data is blocked, indicated by a thin line, the generation of a loop is prevented.

In FIG. 2 the device A, which is a layer 2 switch, is a root, and blocking is set between the device C, which is a layer 2 switch, and the device E, and between the device D, which is a layer 2 switch, and the device F, and the generation of a loop is prevented.

In this case, if a failure occurs to tree shaped paths (hereafter called spanning tree), STP suspends all communications in the networ, the spanning tree is recalculated, and a new spanning tree is reconstructed. This processing however requires several tens of seconds, and communication in the network stops, so a communication quality problem may be generated.

The Rapid Spanning Tree Protocol (RSTP) defined in IEEE 802.1w, is for dealing with this problem. When there is a port to be an alternate path in each layer 2 switch, this port is explicitly specified to a designated port.

And if a failure occurs to a port in use (root port) in the spanning tree, the port in use in the spanning tree can be immediately switched to the designated port. By this method, a quick recovery from the failure becomes possible.

FIG. 3 is a diagram depicting an example of the recovery operation using the above mentioned RSTP. In the path setting in FIG. 3A, an alternate path, when a failure occurs between the device A and the device C, is set in advance. In other words, a root port and a designated port, when the device C becomes a root, are set for the device C.

Therefore if a failure X occurs between the device A and the device C, the path between the device C and the device D is activated by switching to the designated port of the device C, as shown in FIG. 3B, where quick switching is possible.

Also by introducing MSTP defined in IEEE 802.1s, a redundant configuration of the network is implemented, and communication, where a location where device failure or cable disconnection occurs is detoured, is made possible, and a different transmission path can be set for each VLAN-ID. Therefore traffic and load on an entire network can be distributed, and high reliability and performance can be provided.

FIG. 4 shows a configuration example of a redundant network where MSTP is introduced. It is assumed that the first spanning tree of which root is the device B1 (VLAN-ID=1) and the second spanning tree of which root is the device B2 (VLAN-ID=2) are set.

If a failure X, such as a cable disconnection, occurs between the devices B1 and B4, a communication using a detour by the second spanning tree is implemented, and as a result both VLAN-ID=1 and 2 have the same tree configuration.

The example in FIG. 5 is a load distributed network configuration example where MSTP is introduced. In the paths of the spanning trees of VLAN-ID=1 and 2, the load is distributed between the devices B1 and B4 and the devices B2 and B3.

As FIG. 1 shows, in the case of a wide area LAN service, in which a plurality of companies construct private networks using a same physical lines, the transmission data must not be leaked among the companies. For this reasons, a VLAN-ID unique to each company is assigned, and the data destination is decided based on the VLAN-ID.

By this, the leak of data to another company having a different a VLAN-ID can be prevented.

MSTP here is a protocol which allows the construction of a plurality of topologies and mapping each VLAN to an arbitrary topology in a network where a plurality of VLAN traffic exists, rather than constructing a same topology for all the VLANs.

By this, a path, which is physically connected but is not used because of blocking status, can be used for another spanning tree. Therefore the load distribution of the network becomes possible.

In MSTP, topologies in which a same transmission path is set are called an MSTI (Multiple Spanning Tree Interface), and a plurality of VLAN-IDs can be registered to one MSTP. The device in which MSTP is operating manages the MSTI number and VLAN-IDs belonging to the MSTI, and holds this information as one table (correspondence table between VLAN-ID and MSTI). FIG. 6 shows an example of this correspondence table.

Mutual information including the correspondence table between VLAN-IDs and MSTI, as shown in FIG. 6, is exchanged between the layer 2 switch devices adjacent to each other, so MAC frames called BPDU (Bridge Protocol Data Unit) defined in IEEE 802.1s are transmitted and received from each other.

A BPDU cannot be divided into a plurality of MAC frames and transmitted, but must be transmitted contained in one frame. FIG. 7 shows an example of the contents of a BPDU frame.

In FIG. 7, a VLAN-ID is in the 0-4095 range, so the correspondence table between a VLAN-ID and MSTI becomes larger than the size limit of an Ethernet frame which is a 1500 octet. Therefore in the transmission side device, the correspondence table between VLAN-ID and MSTI is not transmitted/received directly, but the entire 0-4095 of VLAN-ID in the correspondence table between VLAN-ID and MSTI in FIG. 6 is calculated using a hash function called MD (Message Digest) 5. And the result of converting into 16 octets (74-89 octet positions), as shown in the table in FIG. 8, is stored in the MAC frame and sent to the adjacent device.

MD (Message Digest) 5 has a unidirectional hash function, and can generate a 128 bit fixed length hash value with respect to an arbitrary length information.

FIG. 9 is a diagram depicting a conventional conceptual configuration example of a device which functions as a layer 2 switch. The device to be a receive side extracts the hash value at the hash information extraction section 10 from the received MAC frame.

In the hash value comparison section 11A of the topology change detection processing section 11, the extracted hash value is compared with the hash value calculated by the hash value calculation section 12A of the network identification information processing section 12 based on the correspondence table between VLAN-ID and MSTI (see FIG. 6) stored in the MSTP record section 13.

If there is a difference in the comparison result of the hash values, the topology information construction section 11B reconstructs the topology tree. The result of the reconstruction of the topology tree is reflected in the MSTP record section 13.

The hash value calculated by the hash value calculation section 12A is stored in the frame in the hash information insertion section 14, and is sent to the adjacent device.

In MSTP, an area to which a device having a same correspondence table between VLAN-ID and MSTI belongs is called a “region”. FIG. 10 is a diagram depicting a region. In FIG. 10, the device 1 to device 6 are devices corresponding to the layer 2 switches that support MSTP. The device 1 to device 5 belong to the same region 1, but the device 6 has a different correspondence table between VLAN-ID and MSTI. So the region thereof is a different area, region 2, and MSTP cannot be used between the device 5 and device 6.

Therefore the communication carrier creates a region in area units, so that the failure range can be controlled to be small.

If the users of a wide area LAN service increase, an MSTI is newly added where VLAN-IDs are assigned, or a VLAN-ID is additionally assigned to a conventional MSTI.

If a VLAN-ID is added to the device 5 to add users, the hash value which the device 5 calculates based on the correspondence table between VLAN-ID and MSTI and the hash value calculated by the adjacent device 2 are different, so the device 5 is excluded from the region 1, and MSTP in the region 1 is reconstructed by the remaining device 1 to device 4. As a consequence, the reconstructed MSTP region becomes like FIG. 11.

Because of adding a VLAN-ID, a conventional spanning tree cannot be used between a device excluded from the region 1 and region 2, so a CIST (Common and Internal Spanning Tree), which is a common spanning tree formed inside and outside a region, is set between region 1 and the device excluded from region 2.

In the case of a device where MSTP is operating, the hash value is calculated for the entire correspondence table between VLAN-ID and MSTI, so if a VLAN-ID is added to one MSTI, the adjacent device cannot recognize the MSTI of which information changed. As a consequence, information on an entire MSTI cannot be guaranteed.

For example, in the case of allocating one MSTI to one company, if it is attempted to add a VLAN-ID to an MSTI allocated to one company, this influences the entire wide area LAN, including the networks of other companies using another MSTI belonging to the same region, until a new spanning tree is constructed, and communication is interrupted.

The present applicant has made a proposition related to the reconstruction of a network (Japanese Patent Application Laid-Open No. 2002-204250). In this previously proposed invention, a node on the communication network collects information on traffic on the communication network, and performs load distribution control using this information.

Therefore this invention is not related to an MSTP (Multiple Spanning Tree Protocol) network construction, which is a subject of the present invention.

### DISCLOSURE OF THE INVENTION

With the foregoing in view, it is an object of the present invention to provide a multiple spanning tree protocol (MSTP) network that can guarantee communication other than MSTP where a VLAN-ID is added or deleted.

To achieve this object, a first aspect of the multiple spanning tree protocol network of the present invention is a multiple spanning tree protocol network, connected in plurality via transmission paths, for forming a plurality of topologies wherein each of said plurality of devices comprises: a network identification information processing section for creating network identification information for each of the topology; a receive section for receiving and extracting the network identification information from an adjacent device; and a topology change detection processing section comprising a comparison section for comparing the extracted network identification information with the network identification information of a local device generated by the network identification information processing section, and a topology information construction section for reconstructing only the topology of which change has been detected if the comparison section detects the change.

A second aspect of the multiple spanning tree protocol network for achieving the object of the present invention is the first aspect further comprising a record section for storing virtual LAN identification information which is set for a multiple spanning tree instance, which is each of topologies of the multiple spanning tree protocol, wherein the network identification information processing section comprises a hash value calculation section for extracting virtual LAN identification information from the record section, and calculating a hash value corresponding to each of a multiple spanning tree instance, and a hash table generation section for creating a table using the hash values calculated by the hash value calculation section, and the MSTP network further comprises a hash information insertion section for inserting the hash table generated by the hash table generation section of the network identification information processing section to a predetermined position of a frame to be transmitted to an adjacent device.

A third aspect of the multiple spanning tree protocol network to achieve the object of the present invention is the second aspect wherein the receive section extracts a hash value from a frame received from an adjacent device, and the comparison section compares the hash value extracted by the receive section with the hash value calculated by the hash value calculation section, detects a topology where a topology change has occurred, reconstructs only the topology of which change has been detected by the topology information construction section, and updates the record section according to the result of the reconstruction.

A fourth aspect of the multiple spanning tree protocol network to achieve the object of the present invention is the second aspect, wherein the size of the hash value is set by command input by the user.

A fifth aspect of the multiple spanning tree protocol network to achieve the object of the present invention is the fourth aspect further comprising a hash value detection section for detecting whether hash values before and after change are the same when virtual LAN identification information is added to/deleted from the multiple spanning tree instance in operation, and allows notifying the user that addition/deletion of the instance is disabled if the hash values are the same.

Characteristics of the present invention will be further clarified by embodiments of the invention which will be described herein below according to the drawings.

### BRIEF DESCRIPTION OF THE DRAWINGS

FIG. 1 is a diagram depicting the wide area LAN service of a prior art using VLAN;

FIG. 2 is a diagram depicting a configuration example of the spanning tree by STP;

FIG. 3 is a diagram depicting the recovery operation example using RSTP;

FIG. 4 is a diagram depicting a configuration example of a redundant network using MSTP;

FIG. 5 is a diagram depicting a configuration example of a load distributed network using MSTP;

FIG. 6 shows a VLAN ID-MSTI correspondence table of a local device;

FIG. 7 shows an example of the contents of a BPDU frame;

FIG. 8 is a table showing the result of conversion into 16 octets (74-89 octet positions);

FIG. 9 is a diagram depicting a conventional conceptual configuration example of a device which functions as a layer 2 switch;

FIG. 10 is a diagram depicting a region;

FIG. 11 is a diagram depicting a reconstructed MSTP region;

FIG. 12 is a diagram depicting a conceptual configuration of a device of a layer 2 switch according to the present invention;

FIG. 13 is a diagram depicting hash value calculation in the hash value calculation section 12A from the VLAN ID-MSTI correspondence table;

FIG. 14 is a diagram depicting the table setting of a hash value result calculated by the hash table generation section 12B;

FIG. 15 is a diagram depicting the processing of comparing the hash calculation result of a local device and the hash result of the adjacent device for each MSTI in the hash value comparison section 11A;

FIG. 16 is a table showing the decision of hash size or number of MSTIs that can be set in 128 bits;

FIG. 17 is a diagram depicting the case of changing topology information such as the VLAN configuration of MSTP;

FIG. 18 is a diagram depicting the network configuration example used for describing an embodiment of the present invention;

FIG. 19 is a diagram depicting a case of using the wide area LAN service in FIG. 18, wherein the company C uses VLAN-ID=3 and the branch LAN and head office LAN of the company C are connected to the devices B1 and B2;

FIG. 20 is a diagram depicting the spanning tree of which root is the device B2 in FIG. 19;

FIG. 21 is a diagram depicting the spanning tree of which root is the device B1 in FIG. 19;

FIG. 22 is a diagram depicting a common tree, that is the CIST (Common and Internal Spanning Tree) in FIG. 19;

FIG. 23 shows the VLAN ID-MSTI correspondence table which is managed in the device B1-B4 respectively before the company C connects a private network via VLAN;

FIG. 24 is a diagram depicting the processing when the company C connects a private network to the device B1 via VLAN;

FIG. 25 is a table describing the update of the VLAN ID-MSTI correspondence table in the device B1;

FIG. 26 is a diagram depicting the hash calculation in the device B1;

FIG. 27 is a table describing the table setting of one octet of the result after hash calculation is performed for each MSTI;

FIG. 28 is a diagram depicting the processing at the devices B2 and B4 which received BPDU from the device B1;

FIG. 29 is a diagram depicting the processing at the device B3 which received BPDU from the devices B2 and B4;

FIG. 30 is a diagram depicting the status where communication is possible using MSTI since there is no change in the device configuration other than MSTI=1;

FIG. 31 is a diagram depicting the processing of registering VLAN-ID=3 to the port 3 of the device B2, and registering VLAN-ID=3 to MSTI=1 at the same time;

FIG. 32 is a table showing the update of the VLAN ID-MSTI correspondence in the device B2;

FIG. 33 is a diagram depicting the hash calculation processing in the device B2;

FIG. 34 is a table showing the table setting of one octet of the result after hash calculation is performed for each MSTI;

FIG. 35 is a diagram depicting the comparison of the hash result in the device B3;

FIG. 36 is a diagram depicting the comparison of the hash result in the device in B2;

FIG. 37 is a diagram depicting the comparison of the hash result in the device in B1;

FIG. 38 is a diagram depicting the status where communication is possible by continuously using MSTP for topologies of which device configuration does not change;

FIG. 39 is a diagram depicting the hash calculation processing when the number of MSTIs to be set is the maximum 16;

FIG. 40 is a diagram depicting the processing of table setting based on the hash size, which is the hash result in the hash table generation section 12B;

FIG. 41 is a diagram depicting the processing of comparing hash values based on the hash size which is set by the hash value comparison section 11A;

FIG. 42 is a diagram depicting the processing of the MSTP device when the hash size is 4 bits;

FIG. 43 is a diagram depicting the processing of table setting for each MSTI based on the hash size determined in FIG. 40 by the hash table generation section 12B;

FIG. 44 is a diagram depicting the processing of comparing hash values based on the hash size which is set by the hash value comparison section 11A; and

FIG. 45 is a table showing the case when a VLAN ID is newly added to the MSTI in current operation.

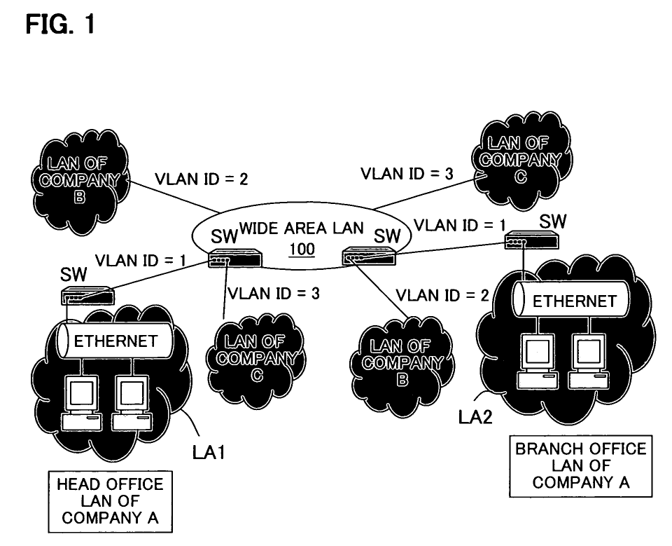

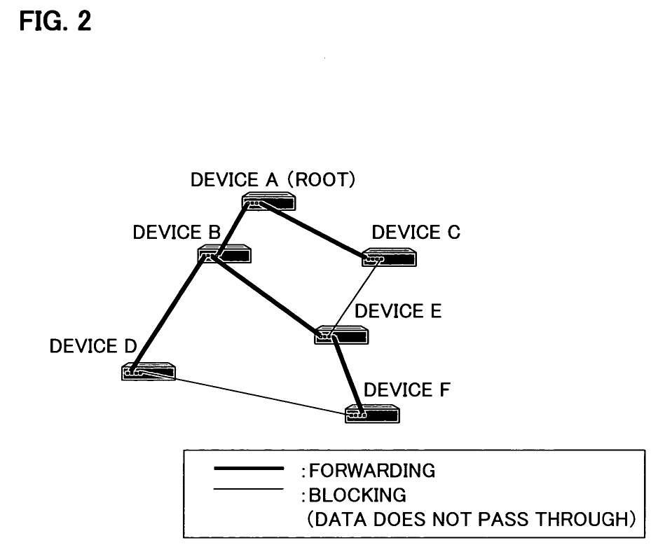

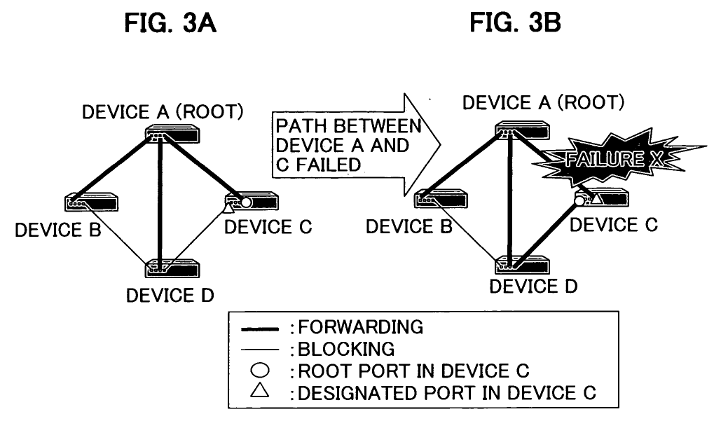

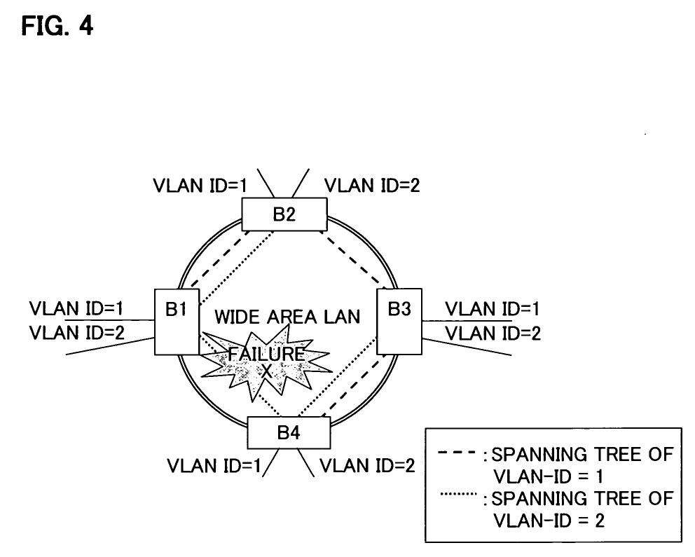

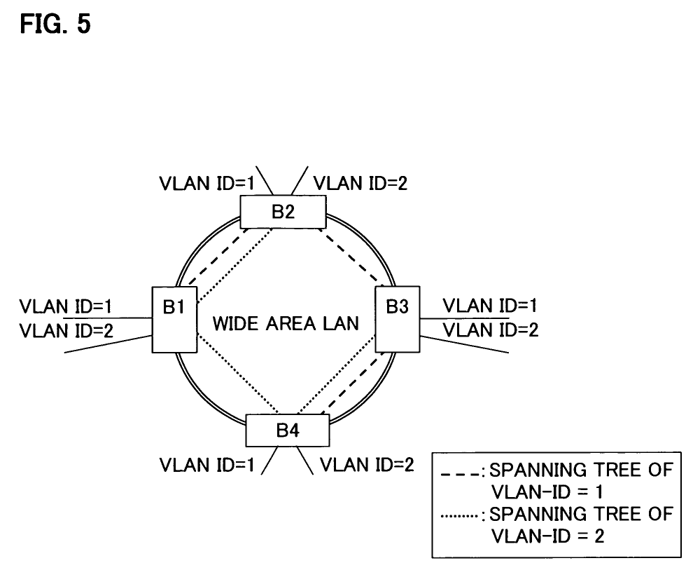

### BEST MODE FOR CARRYING OUT THE INVENTION

Embodiments of the present invention will now be described with reference to the drawings. Embodiments are for understanding the present invention, and the technical scope of the present invention shall not be limited thereby.

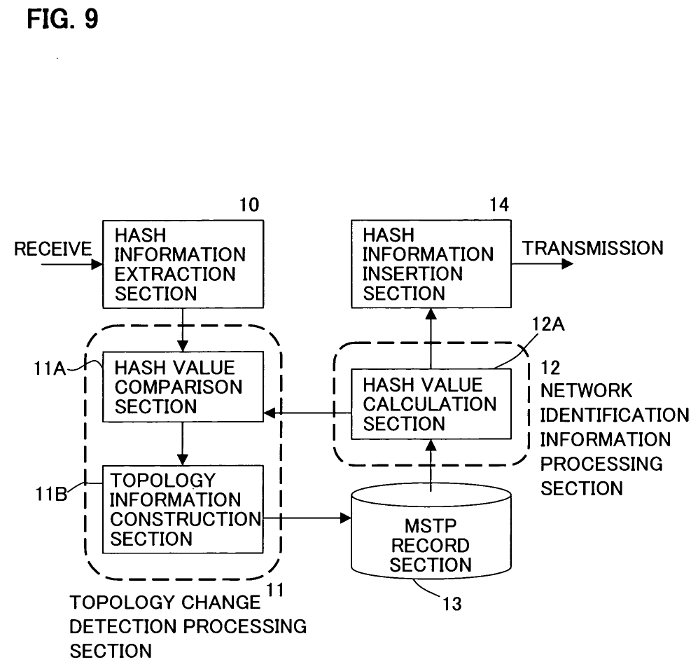

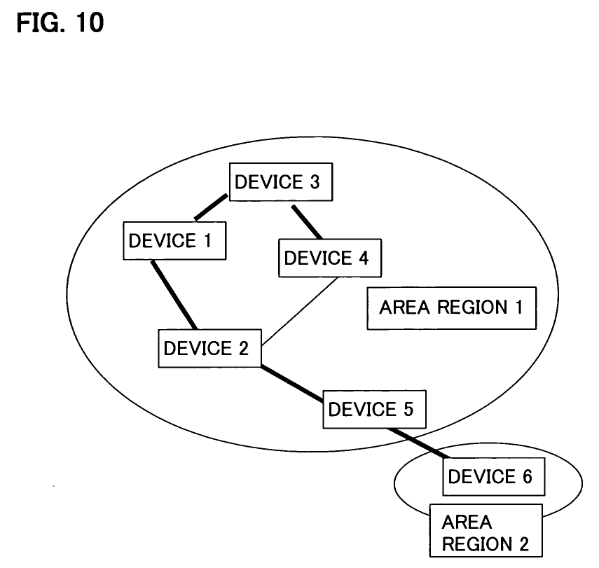

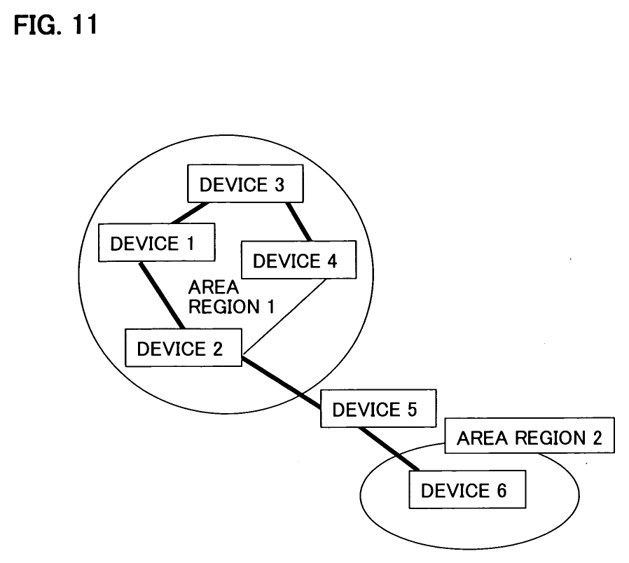

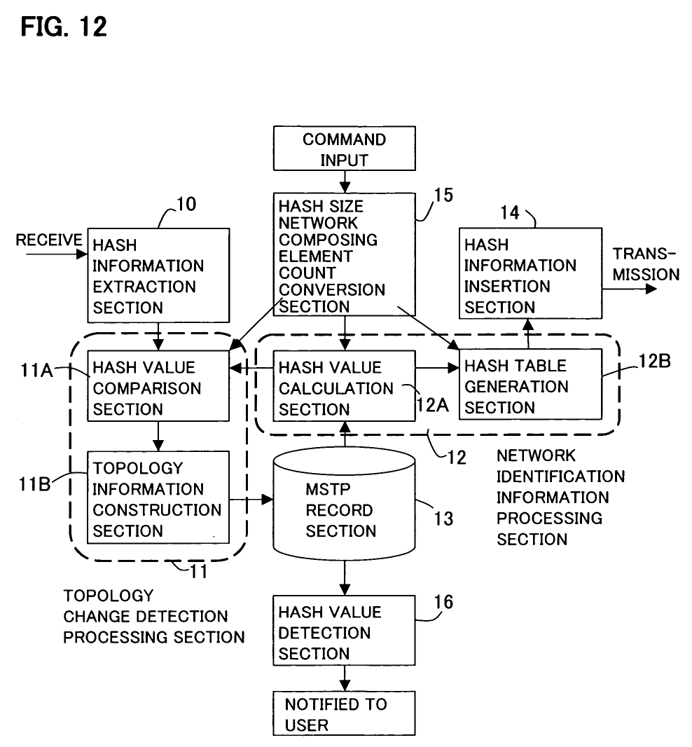

FIG. 12 is a diagram depicting the conceptual configuration of the device of the layer 2 switch according to the present invention. Compared with the conceptual configuration of the conventional device shown in FIG. 9, the network identification information processing section 12 further comprises the hash table generation section 12B, and the network composing element conversion section 15 and the hash value detection section 16 are also included.

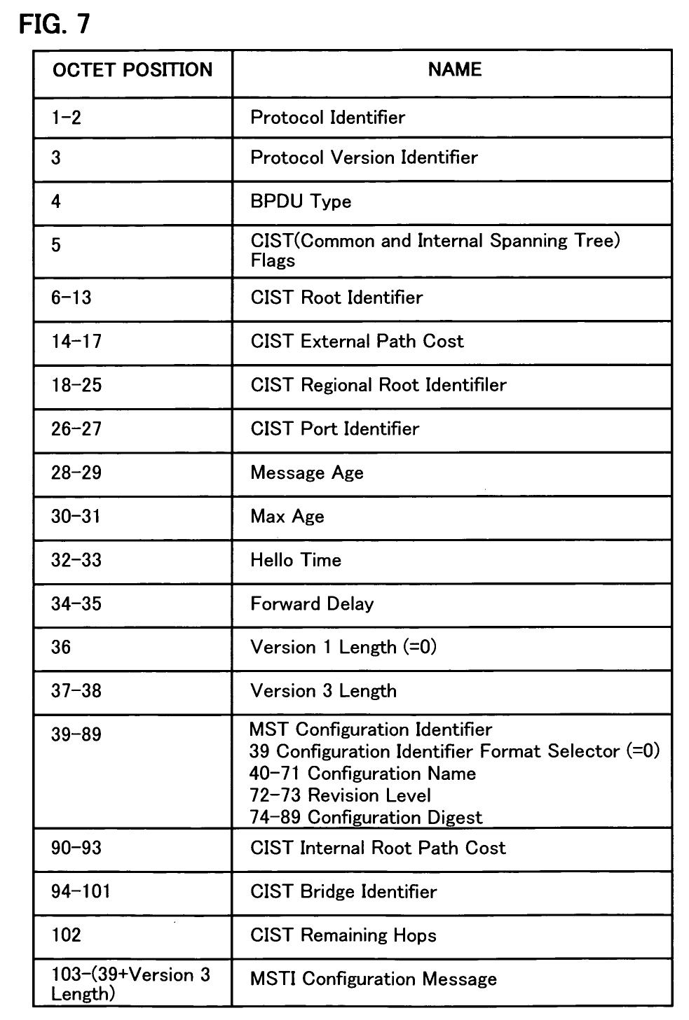

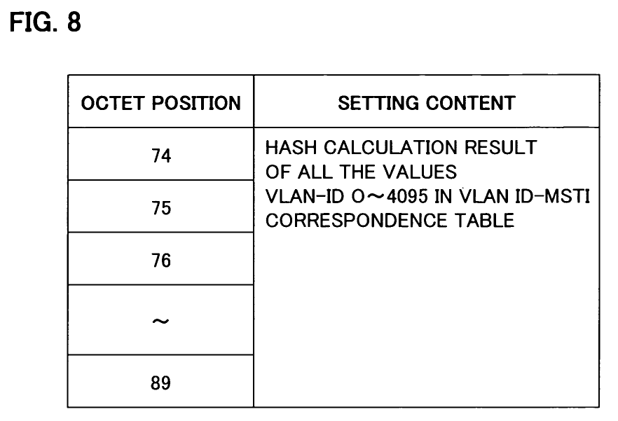

In FIG. 12, the hash information extraction section 10 extracts the CD (Configuration Digest), which is the hash calculation result of 74-89 octet portions (16 octets) in the MST configuration identifier of 39-89 octet positions in the BPDU frame (see FIG. 7), which is a MAC frame received from an adjacent device.

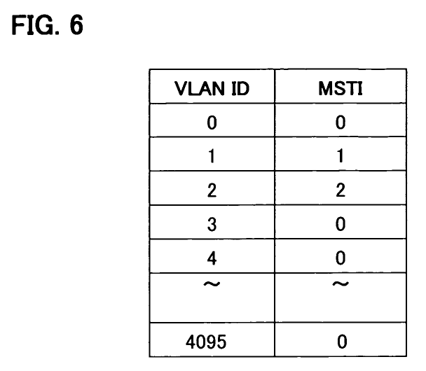

The hash value comparison section 11A of the topology change detection processing section 11 compares the CD (Configuration Digest) extracted from the received BPDU frame by the hash information extraction section 10, and the hash value calculated from the VLAN ID-MSTI correspondence table (see FIG. 6) of the local device by the hash value calculation section 12.

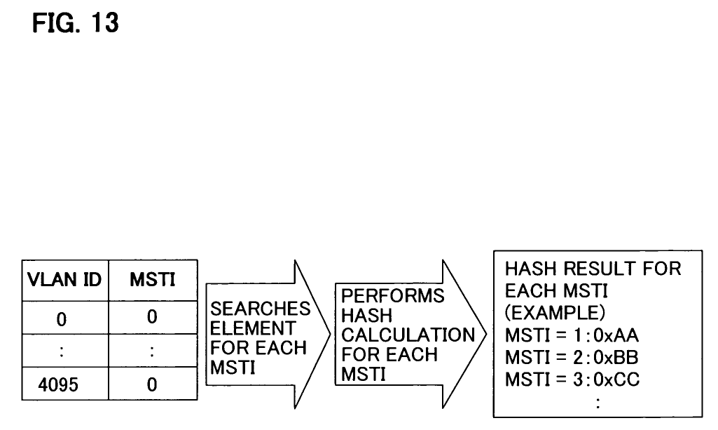

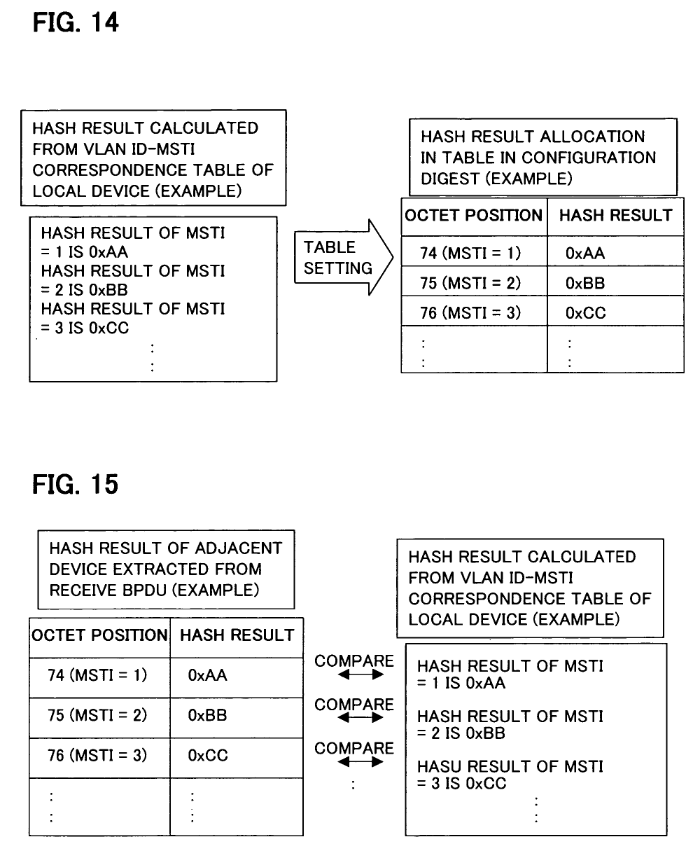

FIG. 13 and FIG. 14 are diagrams depicting the hash value calculation in the hash value calculation section 12A.

In FIG. 13, an example of a VLAN ID-MSTI correspondence table, is shown at the left. From this correspondence table, the hash value is calculated for each MSTI. To the right of FIG. 13, the hash values of the calculation result for each MSTI are shown.

Here the function and procedure for converting the enumeration of character strings, such as the hash function documents and numbers, into a predetermined length of data, are called a “hash function”, and the value which is output through this function is called the “hash value” or simply “hash”. The hash function is a unidirectional function, so it is impossible to estimate the original from the generated data.

The hash values calculated in this way are used for the table setting of the hash result, as shown at the right of FIG. 14 by the hash table generation section 12B.

In the generated table shown in FIG. 14, the position of an octet is determined for each MSTI, and the corresponding hash value is registered. Then the topology information construction section 11B reconstructs the tree of MSTP of which the difference is detected in the hash value comparison. And the MSTP of which topology is changed is identified, and if change was detected, the stored information in the MSTP record section 13 of the local device is updated.

The hash value information insertion section 14 inserts the hash value (16 octets) into the “Configuration Digest” (74-89 octets) portion in the MST “configuration identifier” in the BPDU to be transmitted to an adjacent device.

The hash value generation section 12B sequentially places the hash value for each MSTI into a corresponding section of the “Configuration Digest” (74-89 octets) portion.

The network composing element conversion section 15 converts the size or total number of MSTPs to be hash-calculated into the value which is input as a command by the user, and sets the corresponding values to the hash value calculation section 12A, hash table generation section 12B and has value comparison section 11A.

The hash value detection section 16 identifies whether the hash result becomes the same or not between before and after network construction, and notifies this information to the user in advance.

By the above configuration, according to the present invention, hash calculation is performed first for each MSTI, and the result is stored in the “Configuration Digest” of the MST “configuration identifier” in the BPDU, and is sent to an adjacent device.

In the present invention, instead of performing hash calculation on all the VLAN-IDs 0 to 4095 as the prior art, hash calculation is performed for each MSTI, therefore only a changed MSTI can be updated and sent to an adjacent device.

Operation of an embodiment will now be described based on the above conceptual configuration.

In a device where MSTP is operating, the VLAN ID-MSTI correspondence table in the local device is acquired from the MSTP record section 13, and the information is notified to the network identification information processing section 12.

In the network identification information processing section 12, which received the VLAN ID-MSTI correspondence table from the MSTP record section 13, the hash value calculation section 12A searches elements for each MSTI in the VLAN ID-MSTI correspondence table, as shown in FIG. 13, according to the present invention, and performs hash calculation, and acquires the hash result for the number of MSTIs, unlike the prior art wherein hash calculation is performed on all the information in the VLAN ID-MSTI correspondence table as one input data, and one result is received.

In a conventional device, this hash calculation result is inserted into the BPDU, which is directly sent to an adjacent device, but in the present invention, the hash table where the hash calculation result is listed on a table for each MSTI, as shown in FIG. 14, is generated in the hash table generation section 12B.

The generated hash table is set to the “Configuration Digest” (74-89 octet positions) in the BPDU in the hash table information insertion section 14, and is sent to an adjacent device.

By this, only the changed MSTI can be updated and sent.

As a second characteristic of the present invention, the hash value for each MSTI is compared, and a topology change is detected and the network is reconstructed.

In the present invention, unlike the prior art where the entire hash result stored in the BPDU received from an adjacent device and the entire hash result in the self device are compared, each hash result divided for each MSTI is compared, so the changed MSTI can be specified and reconstructed.

Now operation of the device which received the BPDU from an adjacent device will be described. When a device where MSTP is operating receives the BPDU from an adjacent device, the network identification information of the MSTI stored in the “Configuration Digest” of the MST “configuration identifier” is extracted in the hash information extraction section 10.

Also in the hash value comparison section 11A of the topology change detection processing section 11, the network identification information of the adjacent device extracted from the received BPDU and network identification information calculated from the local device are compared, and the difference between the devices is detected. If there is a difference in this detected result, the tree of only the detected portion is reconstructed.

The hash information extraction section 10 receives BPDU from the adjacent device, and extracts the network identification information of the MSTP stored in the “Configuration Digest” of the MST “configuration identifier” (hash result of adjacent device).

The MSTP record section 13 acquires the VLAN ID-MSTI correspondence table in the local device. Unlike the prior art where hash calculation is performed on all the data of the VLAN ID-MSTI correspondence table as one input and one hash result is acquired, the hash value calculation section 12A performs hash calculation for each MSTI, as shown in FIG. 13, in the present invention, and the hash result is acquired for the number of MSTIs.

The hash value comparison section 11A compares the hash calculation result of the local device and the hash result of the adjacent device extracted from the received BPDU, as shown in FIG. 15, and it is detected whether there is any change for each MSTI.

If a difference is generated between the hash results for each MSTI, the change of the MSTI is recognized and this MSTI number is notified to the topology information construction section 11B. The topology information construction section 11B, which received the change instruction, reconstructs only this MSTI tree in the present invention, unlike the prior art where the tree is reconstructed for the entire MSTP.

Therefore while a communication disconnection temporarily occurs in the entire MSTP network in the prior art, the change cannot be recognized in the hash value comparison result in the MSTP network other than the changed MSTI, so the tree is not reconstructed, and a communication disconnection is not generated. Because of this, only the changed MSTI can be specified and reconstructed.

As the third characteristic of the present invention, the hash size and total number of MSTIs are changed to change the configuration according to the number of topologies and quality desired by the user.

In the case of a conventional device, 128 bits of hash value is determined from the entire VLAN ID-MSTI correspondence table of the device where MSTP is operating, but in the present invention, the hash result is separated into each MSTI. In this case, the size of the hash value becomes smaller and original quality cannot be maintained.

So it is designed such that the size of the hash result and the number of MSTIs to be set can be arbitrarily selected, then the number of topologies and network quality, according to the user request, can be provided.

For example, if the size of the hash value is increased, the total number of MSTIs that can be set decreases, and the number of topologies also decreases. If the total number of MSTIs that can be set is increased, the size of the hash value decreases, and the probability that the hash values acquired by different inputs become the same increases and the quality of the network drops.

In the following description, processing in the case when each element in FIG. 12 is used and the communication carrier changed the size of the hash value or the total number of MSTIs will be described.

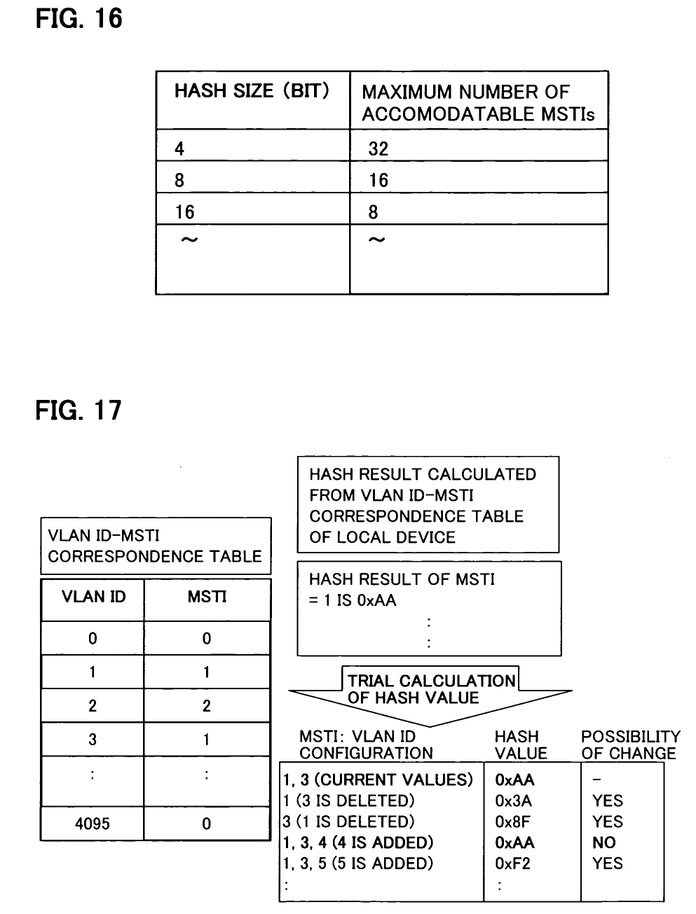

For the hash size or the total number of MSTIs which were specified to an arbitrary value by command input, the hash size or the number of MSTIs that can be set for the 128 bits shown in FIG. 16 are decided by the network composing element count conversion section 15.

This result and the arbitrary set values that was decided are notified to the hash value comparison section 11A, hash value calculation section 12A and hash table generation section 12B.

Based on the number of settings that was notified, the hash value comparison section 11A changes the network identification information of MSTI extracted by the “Configuration Digest” of the MST “configuration identifier” in the BPDU in the hash information extraction section 10, and the hash size and the number of MSTIs for comparing the hash results of the self device.

The hash value calculation section 12A changes the hash size and the number of MSTIs when hash calculation is performed based on the VLAN ID-MSTI correspondence table acquired from the MSTP record section 13.

The hash table generation section 12B also changes the hash size and the number of MSTIs when the result calculated by the hash value calculation section 12A is listed on the table for each MSTI. By this, the number of MSTIs that the communication carrier can accommodate can be arbitrarily set.

As the fourth characteristic of the present invention, trial calculation of the hash result is performed when the MSTI in operation is changed.

In the present invention, unlike the prior art where any VLAN-ID can be added or deleted when the MSTI in operation is changed, it is identified in advance that the hash results before and after do not become the same, so that the status, where the change of topology information cannot be notified or cannot be recognized in spite of an addition/deletion of a VLAN, can be prevented.

In the device where MSTP is operating, the hash value detection section 16 acquires the VLAN ID-MSTI correspondence table in the local device from the MSTP record section 13.

The hash value detection section 16 calculates the hash for each MSTI based on the information of the acquired VLAN ID-MSTI correspondence table.

When topology information, such as the VLAN configuration of MSTP, is changed, the hash value in the case of adding/deleting the VLAN-ID of MSTI is calculated in advance by the hash value detection section 16 as shown in FIG. 17. If the calculation result becomes the same as the previous time by this calculation, the change by adding/deleting the VLAN-ID is disabled, and a notice to prompt selecting another VLAN-ID is sent to the user.

Therefore the contents of the MSTI that can be changed can be specified in advance, and the contents of the change can be notified to an adjacent device with certainty. By this, the status where the change of topology information cannot be notified in spite of the addition of a VLAN can be prevented in advance.

Operation of an embodiment using the above mentioned conceptual configuration according to the present invention will now be further described.

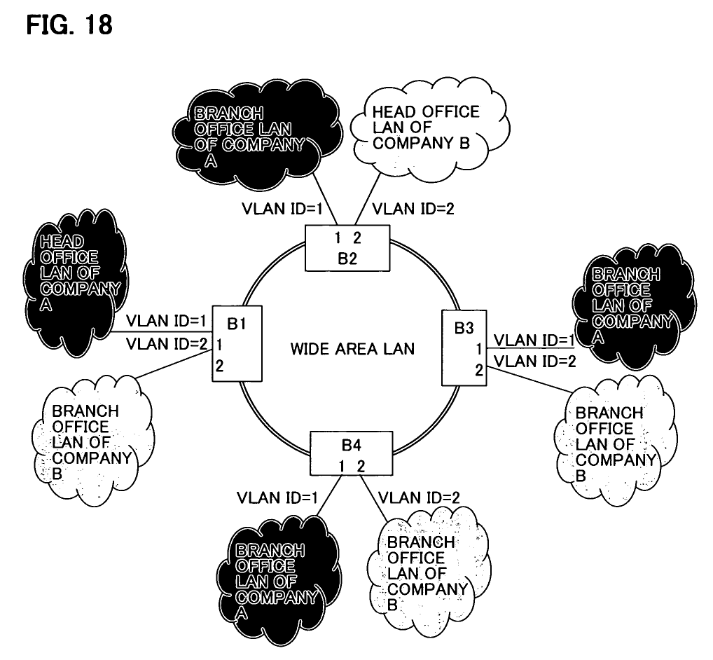

FIG. 18 shows an example of the network configuration to be used for describing the embodiment of the present invention. In the following description of the embodiment, the case when the number of VLANs to be set of MSTI is 2 will be described for simplification, but the present invention can be applied without problems to cases where the number of VLANs to be set is 3 or more.

In the MSTP network configuration in FIG. 18, the company A and company B connect the private networks of the head office or branch office via VLAN respectively, so private networks are connected to the devices B1-B4 which are L2 switching devices hereafter simply called “devices”, and a wide area LAN service is used.

At this time, it is assumed that the identifier of each company which is set at the devices B1-B4 via VLAN connection is company A: VLAN-ID=1, company B: VLAN-ID=2.

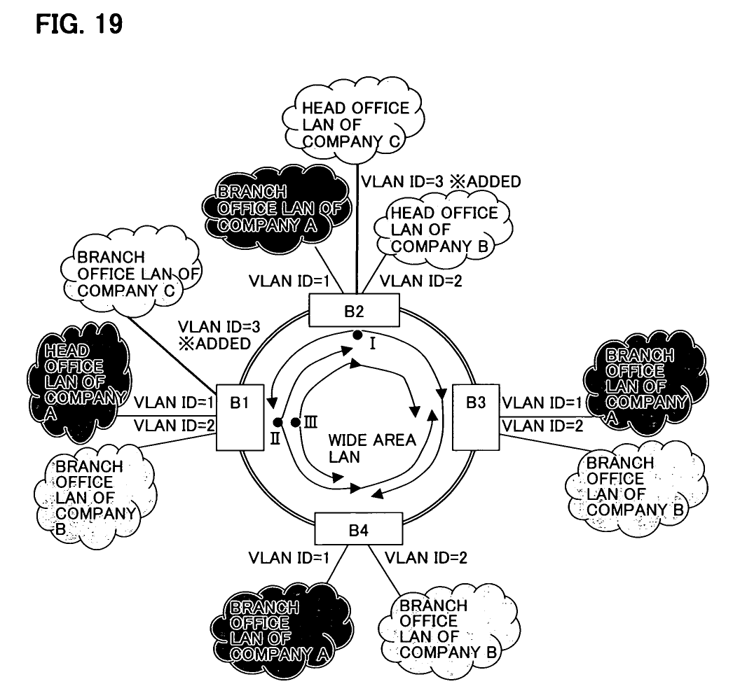

It is assumed that in a status where these companies A and B are forming private networks in the network configuration shown in FIG. 18, the company C is going to use the wide area LAN service by connecting the branch office LAN and head office LAN of the company C to the devices B1 and B2 using VLAN-ID=3, as shown in FIG. 19.

In FIG. 19, each port 1 of the devices B1-B4 of each L2 switch is registered with VLAN-ID=1, and port 2 with VLAN-ID=2.

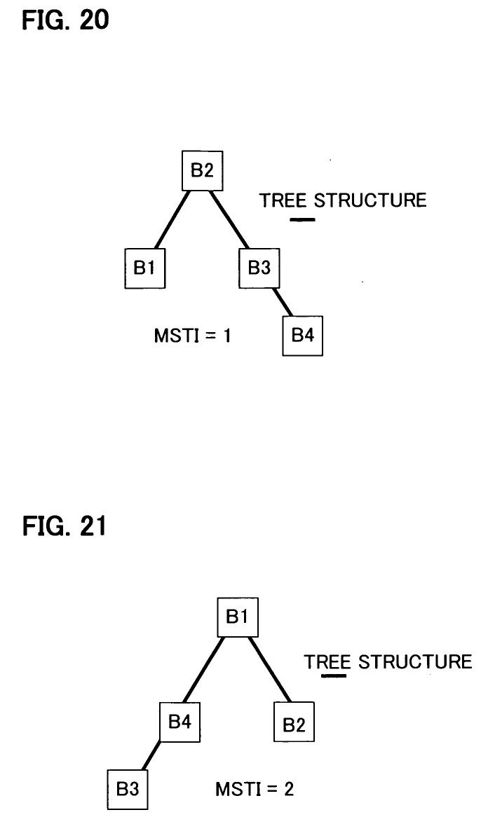

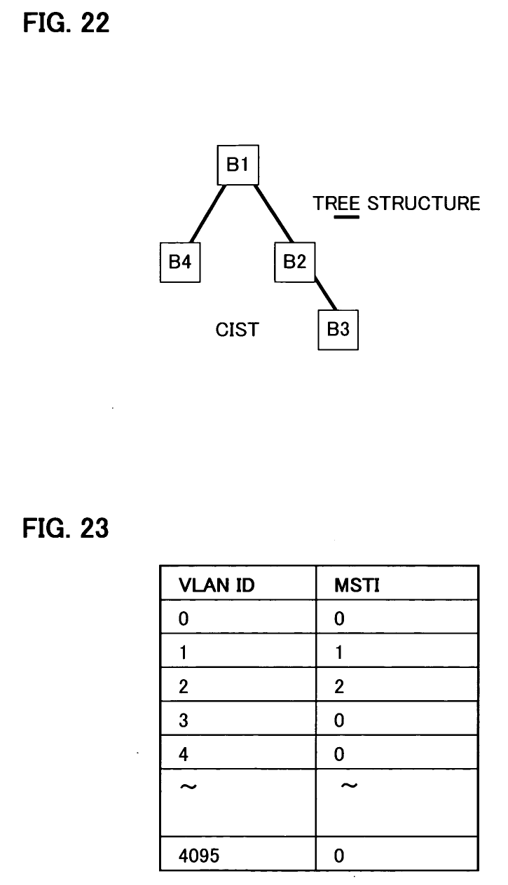

It is assumed that the spanning tree of the user network managed by each device B1-B4 has the configuration shown in FIG. 20 and FIG. 21 respectively for each MSTI, and the common tree, that is CIST (Common and Internal Spanning Tree), has the configuration shown in FIG. 22.

The spanning tree shown in FIG. 20 corresponds to the spanning tree I of which root is the device B2 in FIG. 19, and the spanning tree shown in FIG. 21 corresponds to the spanning tree II of which root is the device B1 in FIG. 19. The spanning tree shown in FIG. 22 corresponds to the spanning tree III of which root is the device B1.

By the above network configuration, the VLAN ID-MSTI correspondence table to be managed by the devices B1-B4 before the company C connects the private networks via VLAN commonly becomes the contents of the table shown in FIG. 23.

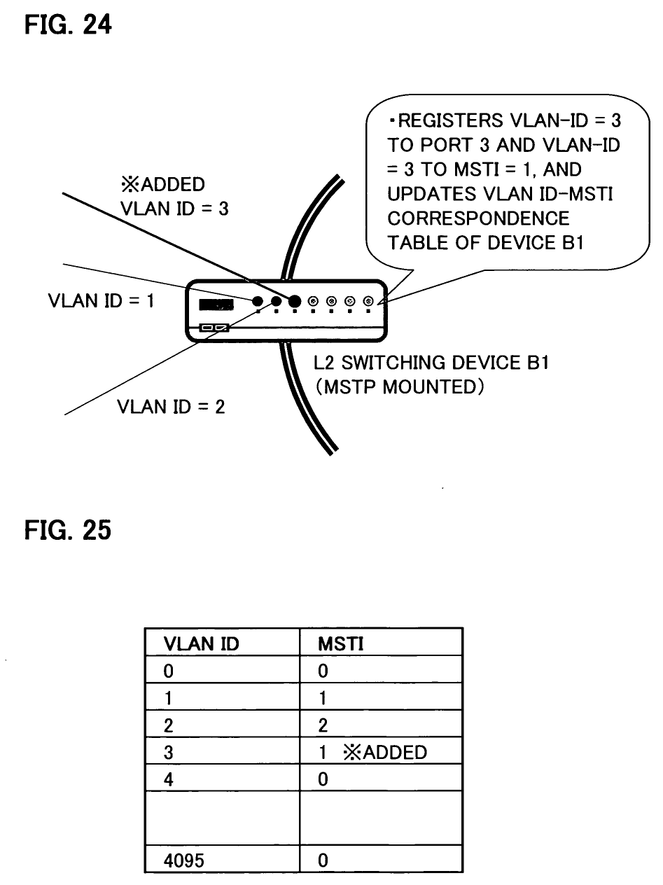

FIG. 24 is a diagram depicting the processing when the company C connects the private network to the device B1 via VLAN.

It is assumed that the identifier for the company C is VLAN-ID=3, and the spanning tree is the same as VLAN-ID 1.

For the setting of the devices, as FIG. 24 shows, VLAN-ID=3 is registered to the port 3 of the device B1, and VLAN-ID=3 is also registered to MSTI=1. According to this, the device B1 updates its own VLAN ID-MSTI correspondence table as shown in FIG. 25. And MSTI=1 is added to the VLAN-ID=1.

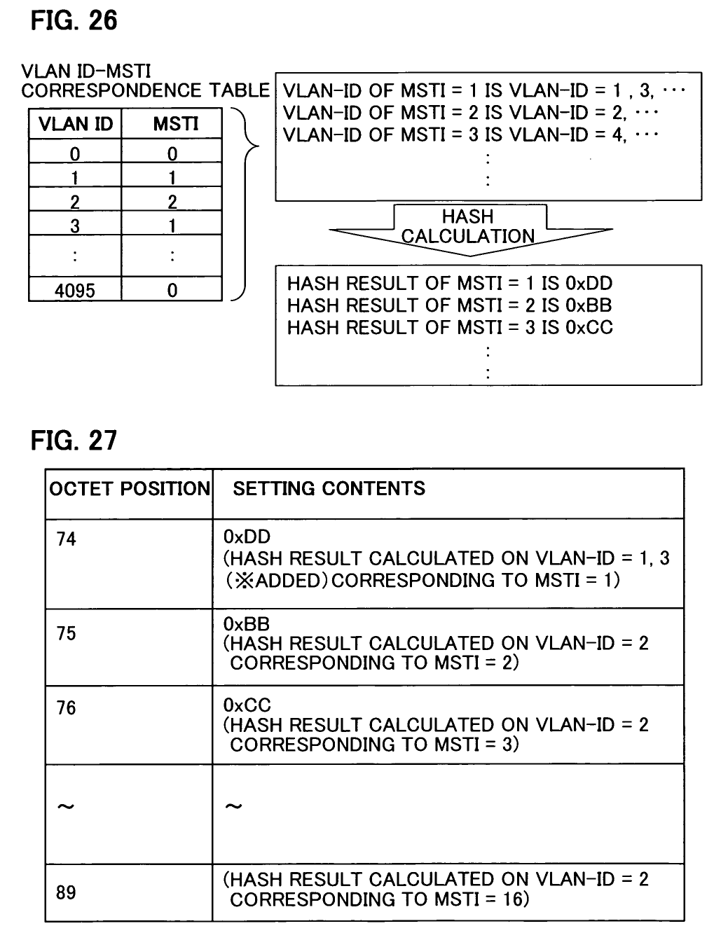

Then in the device B1, the VLAN ID-MSTI correspondence table in the local device is read and searched from the MSTP record section 13, as shown in FIG. 26, and VLAN-ID=1 and 3 included in MSTP=1 are recognized.

Then based on the two information of MSTI=1 and VLAN-ID=1 and 3, hash calculation is performed for each MSTI.

One octet of result after hash calculated for each MSTI is set at the 74^{th} octet corresponding to MSTI=1, as the table in FIG. 27 shows. The search and hash calculation are performed in the same way for the other MSTIs as well, and the result is set at the corresponding position of the MSTI in the table in FIG. 27.

BPDU of MSTP, which includes this calculation result, is sent to the adjacent devices B2 and B4.

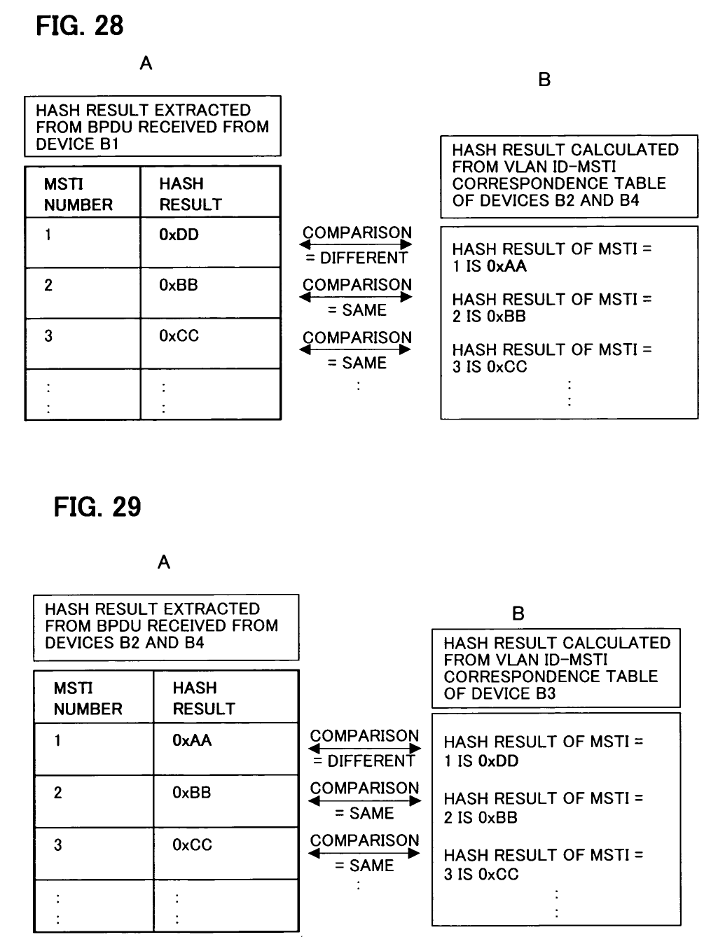

FIG. 28 is a diagram depicting the processing of the devices B2 and B4 which received BPDU from the device B1. The devices B2 and B4 compare the values in the table in FIG. 27 which is set in BPDU extracted by the hash information extraction section 10 (FIG. 12) received from the device B1 (FIG. 28, A) and the hash result, which the local device calculated using the hash value calculation section 12A (FIG. 28, B), sequentially for one octet at a time using the hash value comparison section 11A.

The result of the comparison is a mismatch for MSTP=1, and a match for the other MSTIs, as shown in FIG. 28. Therefore the device B2 and device B4 recognize the change of configuration which occurred in the adjacent device B1 for the MSTI=1 of which the comparison result is a mismatch. And for VLAN-ID=1 and 3 which belong to MSTI=1, the setting is changed from the spanning tree of MSTI=1 (FIG. 20) to the CIST (Common and Internal Spanning Tree) shown in FIG. 22.

Also as FIG. 29 shows, the device B1 compares the hash result (A) extracted from the BPDU received from the devices B2 and B4 and the hash value (B) calculated from the MSTI-ID and MSTI correspondence table of the local device, and recognizes the change of the configuration in the adjacent device for the MSTI=1 of which the comparison result is a mismatch.

And for VLAN-ID 1 and 3 which belong to MSTP=1, the setting is changed from the spanning tree of MSTI=1 in FIG. 20 to the CIST in FIG. 22.

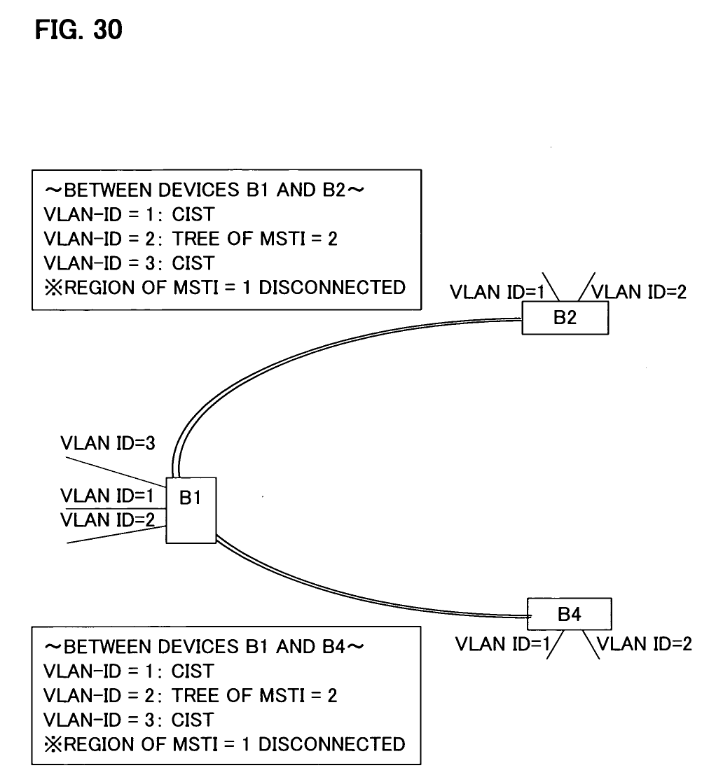

However, as FIG. 30 shows, the configuration of devices did not change except for the MSTI=1 of the devices B1, B2 and B4, so communication can be continued using MSTI.

Now an operation to add VLAN-ID=3 to the device B2, as shown in FIG. 19 in the network configuration shown in FIG. 18, will be described.

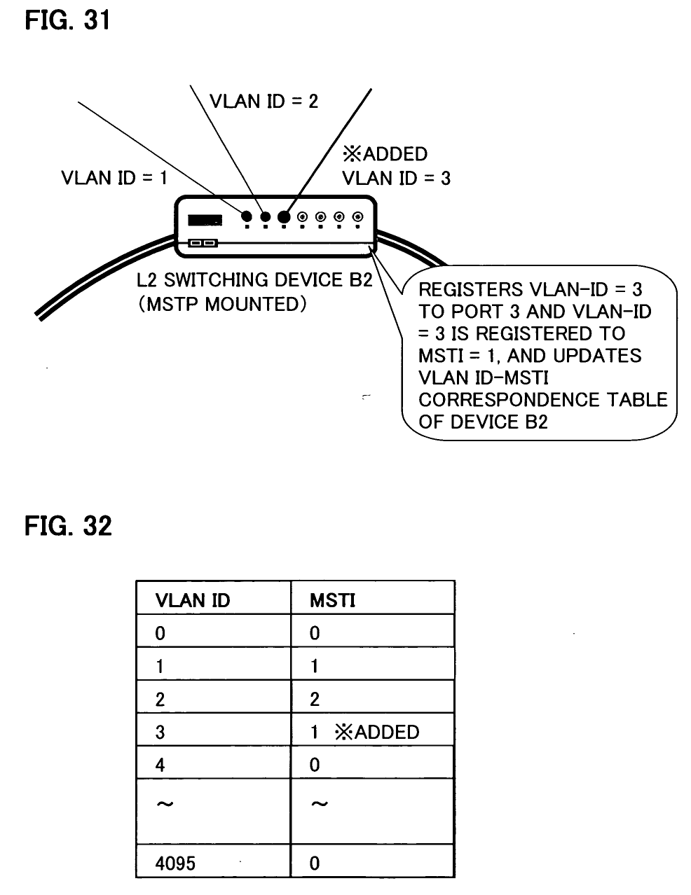

As FIG. 31 shows, VLAN-ID=3 is registered to the port 3 of the device B2 and at the same time, VLAN-ID=3 is registered to MSTI=1.

By this, the device B2 updates the VLAN ID-MSTI correspondence table of the local device, as shown in FIG. 32.

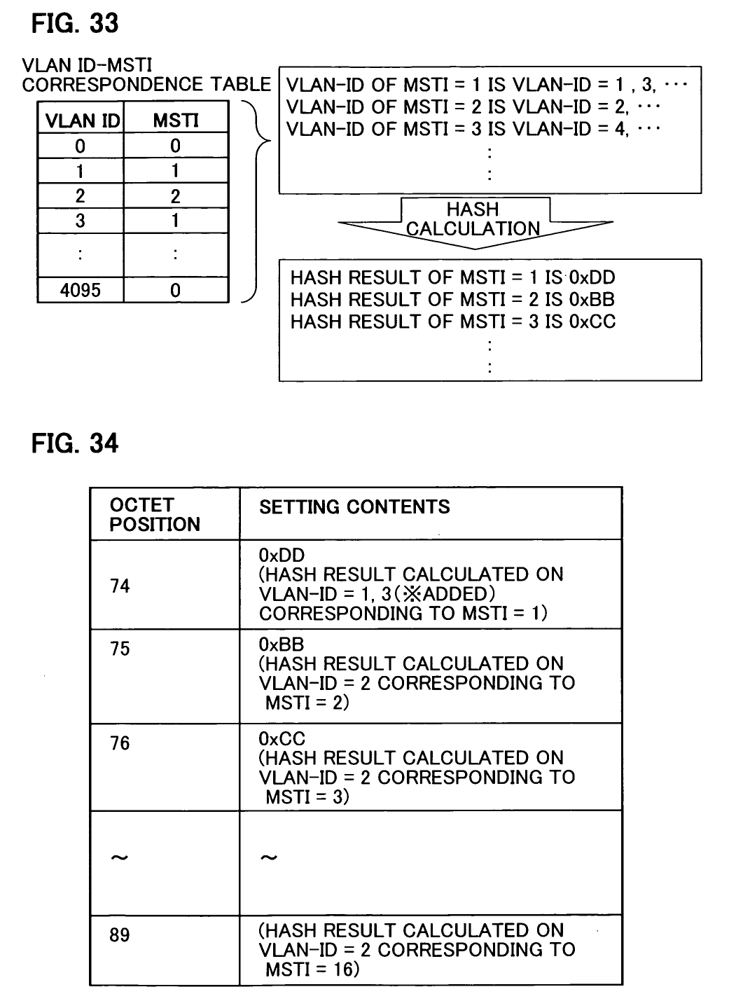

Then the device B2 searches the VLAN ID-MSTI correspondence table in the local device, as shown in FIG. 33, and recognizes VLAN-ID=1 and 3 included in MSTI=1. Then based on the two information of MSTI=1 and VLAN-ID=1 and 3, hash calculation is performed for each MSTI.

One octet of the result after hash is calculated for each MSTI is set at the 74^{th} octet corresponding to MSTI=1, as the table in FIG. 34 shows. The search and hash calculation are performed in the same way for the other MSTIs as well, and the result is set at the corresponding position of MSTI.

BPDU of MSTP, which includes this calculation result, is sent to the adjacent devices B1 and B3.

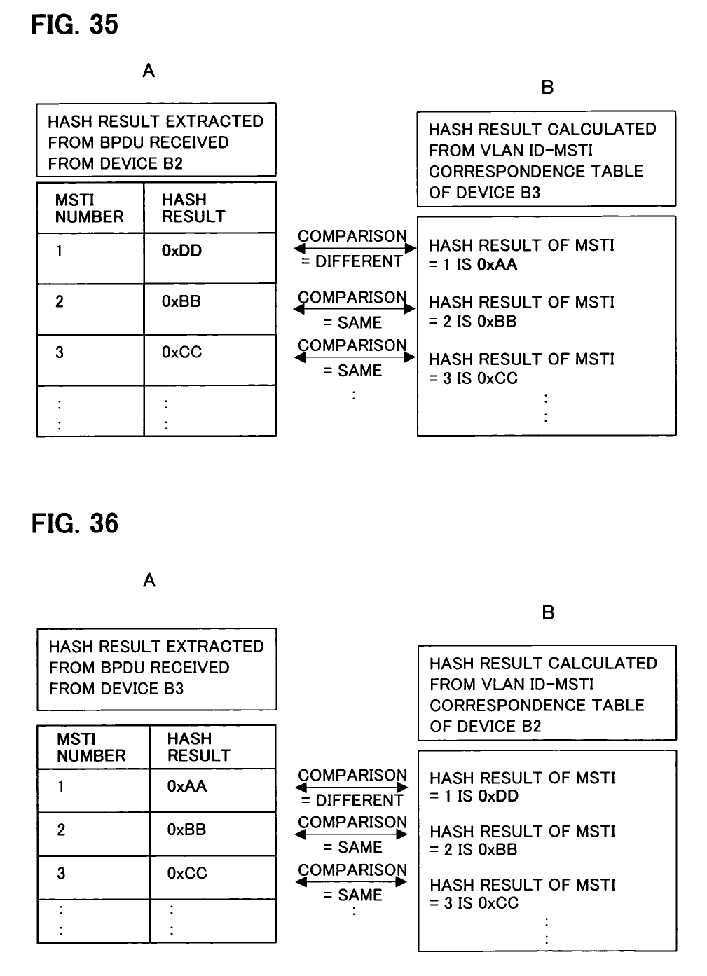

As described above, the device B3 compares the value (A) in the table of FIG. 34 which is set in the BPDU received from the device B2, and the hash result (B) calculated by the local device sequentially for one octet each at a time, as FIG. 35 shows.

And as FIG. 36 shows, the device B2 also compares the hash result (A) extracted from the BPDU received from the adjacent device B3 and the hash result of the local device sequentially for one octet at a time.

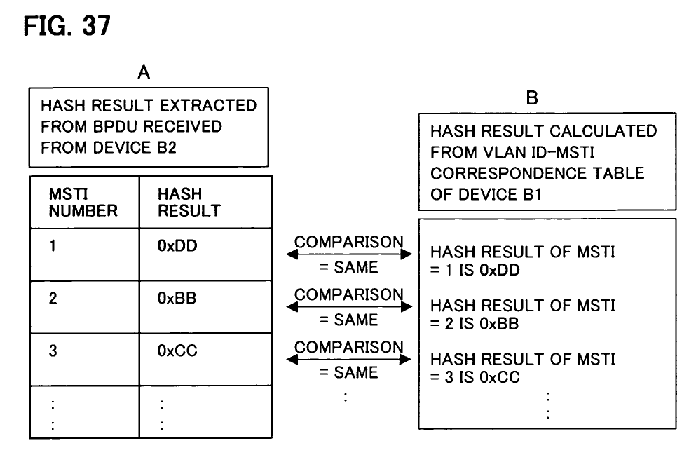

Also as FIG. 37 shows, the device B1 also compares the hash result (A) extracted from the BPDU received from the adjacent device B2 and the hash result (B) calculated by the local device sequentially for one octet at a time.

The comparison result is a mismatch for MSTI=1 between devices B2 and B3, and a match for the other MSTIs. As a result, the device B3 recognizes the change of the configuration at the adjacent device for MSTI=1 of which the comparison result is a mismatch, and changes the setting from the spanning tree of MSTI=1 to CIST (Common and Internal Spanning Tree) for VLAN-ID=1 and 3 which belong to MSTI=1.

For the MSTI=1 of which the comparison result is a match, the device B1 recognizes the change of the configuration in the adjacent device, and changes the setting from the spanning tree of CIST to the spanning tree of MSTI=1 for VLAN-ID=1 and 3 which belong to MSTP=1.

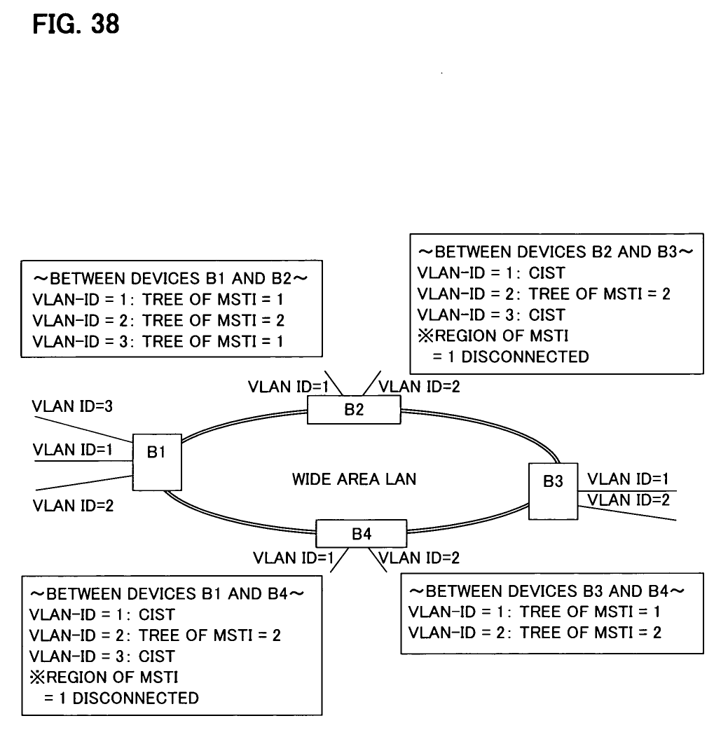

For both the devices B3 and B4, the device configuration did not change except for MSTI=1, as shown in FIG. 38, so communication can be continued using MSTP.

The same procedure is used for the case of adding VLAN-ID=3 to the devices B3 and B4.

As described above, by constructing information of MSTI to be transmitted and received between adjacent devices not for all but for each MSTI, a topology can be constructed only for the changed MSTI.

Now as a second embodiment, an example of changing the size of the hash calculation for each MSTI and arbitrarily setting the number of accomodatable MSTIs in the MSTP device will be described.

The MSTP network configuration is the same as the one shown in FIG. 18. Using this, the operation of the MSTP device with a hash size of 8 bits will be described.

The hash result storing portion in BPDU is fixed to 128 bits (16 octets), so the maximum number of MSTIs to be set in this case is 16.

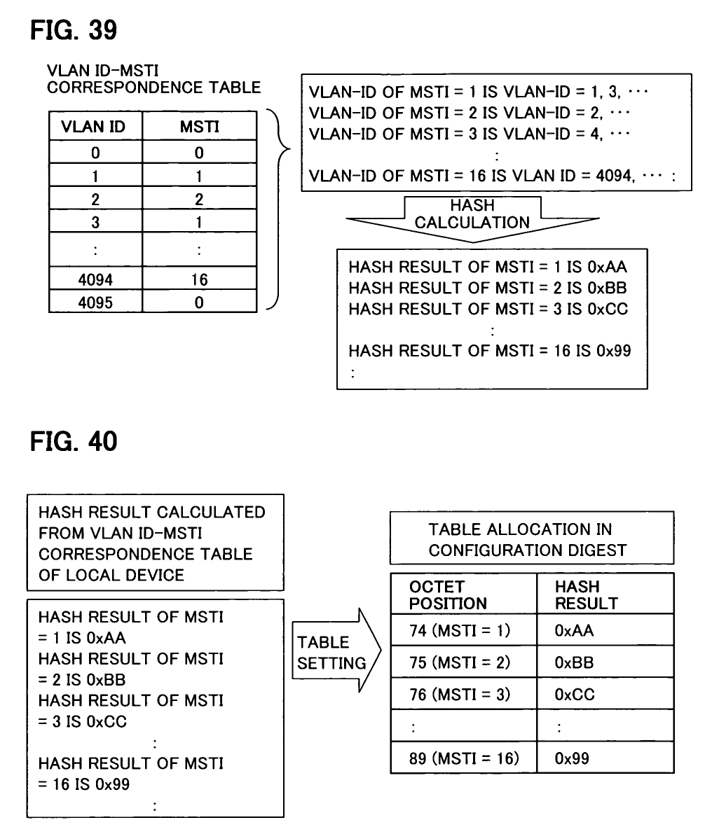

The hash calculation method is as shown in FIG. 39. In other words, the hash value calculation section 12A (see FIG. 12) searches VLAN-ID for each MSTI in the VLAN ID-MSTI correspondence table, and performs calculation using a hash function for generation an 8 bit width hash value.

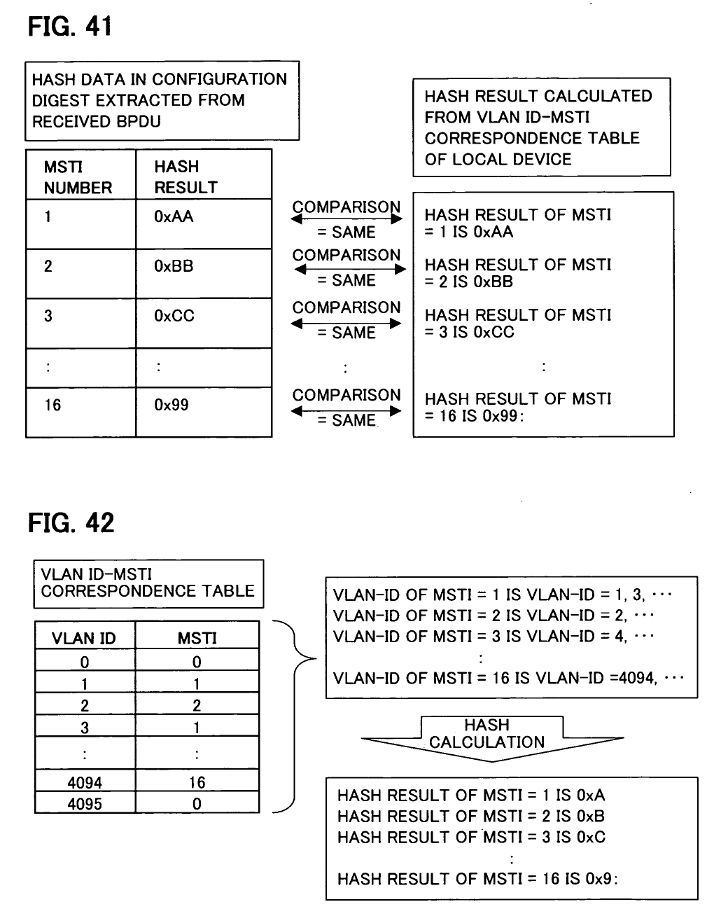

Now hash table generation will be described. As FIG. 40 shows, the hash table generation section 12B sets a table for each MSTI based on the hash size, which is the hash result determined in FIG. 39. The hash value comparison section 11A compares the hash values based on the hash size which is set, as shown in FIG. 41.

FIG. 42 is a diagram depicting the processing of the MSTP device when the hash size is 4 bits. In this case, the maximum number of MSTIs that can be set is 32.

In FIG. 42, the hash value calculation section 12A searches the VLAN-ID for each MSTI in the VLAN ID-MSTI correspondence table, and performs calculation using the hash function for generating a 4 bit width hash value.

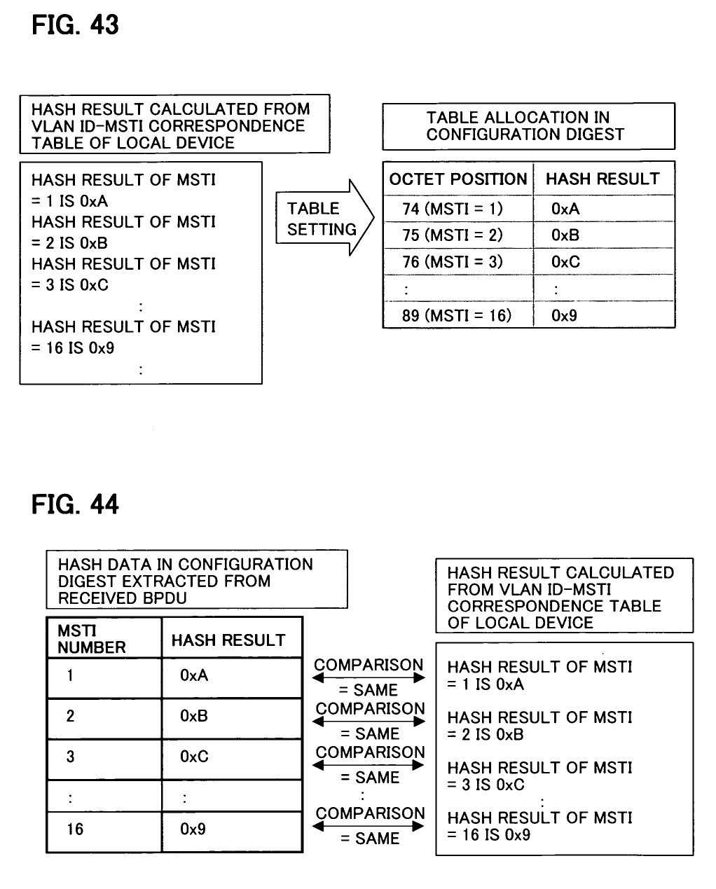

Now hash table generation will be described. As FIG. 43 shows, the hash table generation section 12B sets a table for each MSTI based on the hash size, which is the hash result determined in FIG. 40. The hash value comparison section 11A compares the hash values based on the hash size which is set as shown in FIG. 44.

In this way, information on MSTI to be transmitted/received between adjacent devices is not set to a fixed hash size, but to an arbitrary value, so the number of MSTIs to be set can be freely changed.

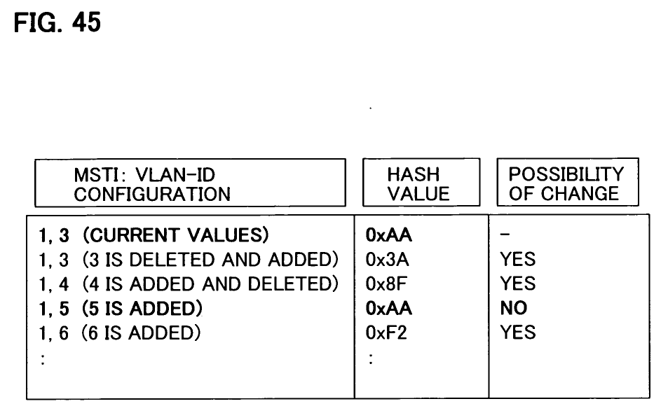

FIG. 45 described the case when a new VLAN-ID is added to the current MSTIs in operation. The MSTP network configuration is as shown in FIG. 18, and the device configuration of the L2 switch is as shown in FIG. 12.

In FIG. 18, the device B1 has set VLAN-ID=1 to MSTI=1, and VLAN-ID=2 to MSTI=2. Both MSTIs are effectively operating in the region.

When a VLAN-ID is added to MSTI=1 in the currently operating device B1, if the VLAN-ID, which was not set in all the VLAN-IDs (0-4095), is added in advance, the hash value detection section 12A calculates the hash value in the case when the VLAN-ID (VLAN-ID which has already been set) is deleted in advance. By this, the VLAN-ID of which hash value is the same before and after the change cannot be changed.

Here if VLAN-ID=5 is added, the hash values become the same before and after the addition, so “VLAN-ID=5 cannot be added to MSTP=1” is presented in advance. The other change patterns are also presented since the possibility of change (adding and deleting) is known. Because of this, a VLAN-ID that can be used can be immediately specified, and setting can be changed.

As described above, an added VLAN-ID is not directly used, but a trial calculation is performed in advance to confirm the hash values before and after addition do not become the same, and the possibility of change is presented, so the problem that the adjacent device cannot recognize the change can be prevented in advance.

### INDUSTRIAL APPLICABILITY

The present invention performs hash calculation for each MSTI, so for MSTI where a VLAN-ID was not added or deleted, no influence occurs and topology is not reconstructed. Therefore the communication carrier can provide highly reliable wide area LAN service.

Also information on whether the hash value becomes the same after addition/deletion of a VLAN-ID is provided to the user in advance. By this, while confirming that no influence occurs to other users in advance, a means of maintaining a wide area LAN network of a specific user can be provided.

1. A data transmission device connected in plurality via transmission paths for forming a plurality of topologies, comprising:
a network identification information processing section for creating network identification information for each of said topology;
a receive section for receiving and extracting said network identification information from an adjacent device; and
a topology change detection processing section, including a comparison section for comparing said extracted network identification information with the network identification information of a local device generated by said network identification information processing section, and a topology information construction section for reconstructing only said topology of which change has been detected if said comparison section detects the change.

2. The data transmission device according to claim 1, further comprising a record section for storing virtual LAN identification information which is set for a multiple spanning tree instance, which is each of topologies of the multiple spanning tree protocol, wherein
said network identification information processing section includes a hash value calculation section for extracting virtual LAN identification information from said record section and calculating a hash value corresponding to each of the multiple spanning tree instances, and a hash table generation section for creating a table using the hash values calculated by said hash value calculation section, and
said data transmission device further comprising a hash information insertion section for inserting the hash table generated by the hash table generation section of said network identification information processing section to a predetermined position of a frame to be transmitted to an adjacent device.

3. The data transmission device according to claim 2, wherein said receive section extracts a hash value from a frame received from an adjacent device, and said comparison section compares the hash value extracted by said receive section with the hash value calculated by said hash value calculation section, detects a topology where a topology change has occurred, reconstructs only the topology of which change has been detected by said topology information construction section, and updates said record section according to the result of the reconstruction.

4. The data transmission device according to claim 2, wherein the size of said hash value is set by command input by the user.

5. The data transmission device according to claim 3, further comprising a hash value detection section for detecting whether hash values before and after change are the same when virtual LAN identification information is added to/deleted from the multiple spanning tree instance in operation, and notifying the user that addition/deletion of said instance is disabled if the hash values are the same.
